(19) United States
(12) Patent Application Publication
(10) Pub. No.: US 2010/0118308 A1
(43) Pub. Date: May 13, 2010

(54) Composite Optical Focusing Devices

(75) Inventors: Tongxin Lu, San Jose, CA (US); Xiaohan Wang, Alameda, CA (US)

Correspondence Address: Venture Pacific Law, PC, 5201 Great America Parkway, Suite 270, Santa Clara, CA, 95054, US

(73) Assignee: Raintree Scientific Instruments (Shanghai) Corporation, Sunnyvale, CA (US)

(21) Appl. No.: 12/436,113

(22) Filed: May 5, 2009

Related U.S. Application Data
(63) Continuation-in-part of application No. 11/735,979, filed on Apr. 16, 2007, now abandoned.

(51) Int. Cl. G01N 21/55

(52) U.S. Cl. 356/445

(57) ABSTRACT

The present invention is an optical system, comprising: a light source for providing light rays; a combined two or more parabolic reflectors or elliptical reflectors having inner reflecting surfaces, wherein the reflectors sharing a common focal point, and a device-under-test is disposed thereabout the focal point; wherein the collimated light rays coming into the parabolic reflector parallel to the axis of symmetry of each parabolic reflector would be directed to the focal point on the surface of the device-under-test. The reflected light rays from the device-under-test are directed by the other parabolic reflectors along the axes of symmetry of each parabolic reflector and generate information indicative of the device-under-test; wherein the reflected light rays exit the reflector; and a detector for receiving the exited light rays.

### PRIORITY CLAIM

This application claims priority to and is a continuation in part from a nonprovisional patent application entitled “Optical Focusing Device” filed on Apr. 16, 2007, having an application Ser. No. 11/735,979. This application is incorporated herein by reference in its entirety.

### FIELD OF INVENTION

The present invention relates to optical illumination and detection systems, and, in particular to, optical inspection and measurement of a reflectance spectrum of a specularly reflecting surface, such as optically polished surfaces, semiconductor wafer surfaces, optical and magnetic storage media, etc.

### BACKGROUND

Information created by directing a beam of light to reflect off a device-under-test (“DUT”) has a variety of uses. For instance, a reflectance spectrum that is reflected off an optically smooth surface contains rich information about the surface and thin films. By analyzing the reflectance spectrum, the thickness and index of refraction of the various coatings (either single layer or multiple layers) on the surface can be determined. This is useful where the reflectance of photoresist coated wafers at the wavelength of lithographic exposure tools must be found to determine proper exposure levels for the wafers, or to optimize the thickness of the resist to minimize reflectance of the entire coating stack. The refractive index of the coating can also be determined by analysis of an accurately measured reflectance spectrum.

It is especially useful, for a variety of industrial applications, to measure the thickness of a very thin film (less than about 300 angstroms in thickness) on a sample, by reflectance measurements of the sample under a microscope. For example, the sample can be a semiconductor wafer, and the very thin film can be coated on a silicon substrate of the wafer.

Because of the tight tolerance requirements typically required in the semiconductor manufacturing arts, an accurate means for obtaining reflectance measurements of a wafer is needed. In conventional reflectance measurement systems, monochromatic or broadband radiation is reflected from the wafer, and the reflected radiation is collected and measured. For example, referring to FIG. 1a, in a traditional measurement and/or inspection system, a lens 100 is used where incoming rays 102 refract through the lens 100 and is focused 104 on the DUT 106 and creates reflectance information that can be analyzed.

High numerical aperture (“NA”) lens (NA˜0.95) has been used to achieve simultaneous wide range of angle of incidence and angle of azimuth. However it has many limitations. First, it is very difficult to extend the wavelength to UV (e.g. below 400 nm) due to the absorption by lens materials at UV wavelengths. Second, it is very difficult to work simultaneously with wide broadband radiation, such as from UV wavelengths to IR wavelengths, due to chromatic aberration in the lenses. Thirdly, as light passes through the lens, there is the issue of the absorption of light where the intensity of the light is diminished as it passes through the lens. Fourthly, as light passes through a lens, the refraction of the light as it passes through the lens is also an issue since the quality of the lens becomes highly critical in order to have good refraction of the light.

To achieve better performance with broadband radiation, reflective optics are preferred. However due to its limited number of design variables, the design choices are also limited; and thus compromises and trade-offs have to be made. For example, the reflective objective of a Schwarzchild design has limited NA and central beam obstruction in order to achieve desired image quality and magnification. It is not a preferred choice for reflectance spectrum measurement of wide incident angle range since its NA is limited.

Aspherical reflective surfaces are also widely used. However, it is mostly used in a very traditional fashion, i.e. the axis of symmetry is perpendicular to the measured surface. The range of angle of incidence is also limited. Most popular forms are paraboloid reflector and ellipsoidal reflector.

By using a half parabolic reflector, a wide range of incident angles can be achieved. However, in order to send collimated rays into the reflector and collect the reflected rays from the reflector, a beam splitter must be used. FIG. 1b is an illustration of a prior art technology for focusing light rays using a two-dimensional half parabolic reflector with a beam splitter. Collimated incoming rays 111 enter a beam splitter 113, and are split into collimated reflected rays 116 and transmitted rays. The transmitted rays reflect through a parabolic reflector 112, and are focused on a focal point 114 of the parabolic reflector 112 that is on the DUT 115. The light is then reflected off the DUT 115; thus, conveying reflectance information that can be analyzed.

There are several issues related to using the beam splitter. The beam splitter will significantly reduce the overall light signal by at least 75%. In reality, it reduces the signal by 90%. Secondly, it is very difficult to make a broadband beam splitter that can work with wide broadband radiation, such as from UV wavelengths to IR wavelengths.

Therefore, it is desirable in optical measurement and inspection systems that the optical beam can be incident on the object from different incidence angles or different azimuthal angles. It is further desirable that the beam is of multiple wavelengths or continuous broadband radiation. It is further desirable that a beam splitter is not used.

### SUMMARY OF THE INVENTION

An objective of the present invention is to provide methods and devices that can achieve a wide angle of incidence range (0 degree to 90 degree) with reflective surfaces.

Another objective of this invention is to provide methods and devices that can simultaneously inspect and/or measure a large device-under-test.

Furthermore, another objective of this invention is to provide methods and devices that minimize the loss of light signal associated with using of beam splitters.

Yet another objective of this invention is to provide methods and devices that can be easily aligned in an optical system with a source and a detector.

The present invention discloses an optical system, comprising: a light source for providing light rays; a combined two or more parabolic reflectors or elliptical reflectors having inner reflecting surfaces, wherein said reflectors sharing a common focal point, and a device-under-test is disposed thereabout the focal point; wherein the collimated light rays coming into the parabolic reflector parallel to the axis of symmetry of each parabolic reflector would be directed to the focal point on the surface of said device-under-test. The reflected light rays from said device-under-test are directed by the other parabolic reflectors along the axes of symmetry of each parabolic reflector and generate information indicative of said device-under-test; wherein said reflected light rays exit said reflector; and a detector for receiving the exited light rays.

An advantage of the present invention is that it provides methods and devices that can achieve a wide angle of incidence range (0 degree to 90 degree) with reflective surfaces.

Another advantage of the present invention is that it provides methods and devices that can simultaneously inspect and/or measure a large device-under-test.

Furthermore, another advantage of this invention is that it provides methods and devices that minimize the loss of light signal associated with using of beam splitters.

Yet another advantage of this invention is that it provides methods and devices that can be easily aligned in an optical system with a source and a detector.

### DRAWINGS

The following are further descriptions of the invention with reference to figures and examples of their applications.

FIG. 1a is an illustration of a prior art technology for focusing a light beam using lenses for inspection and/or measurement systems.

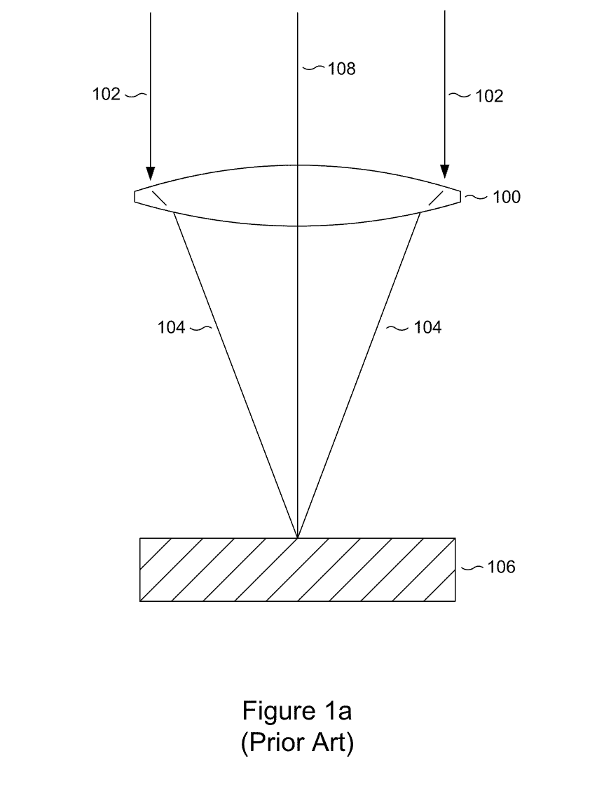

FIG. 1b is an illustration of a prior art technology for focusing a light using a two-dimensional half parabolic reflector with a beam splitter.

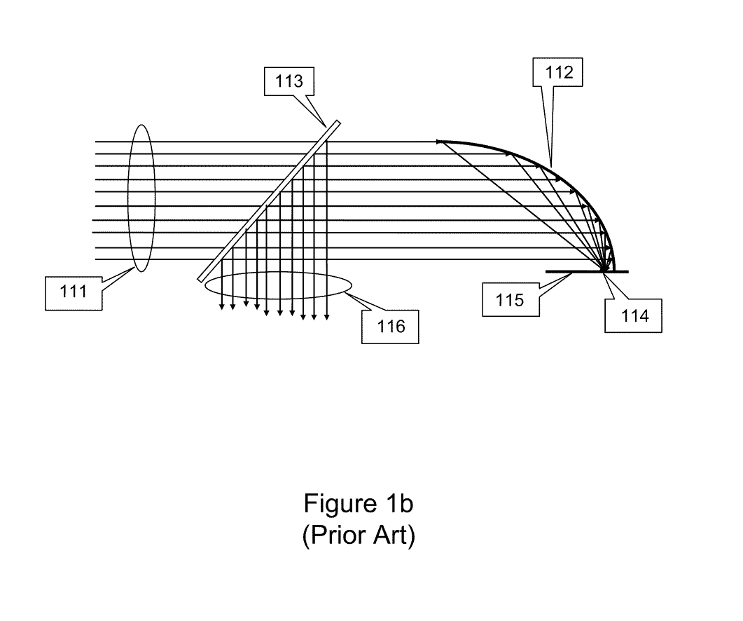

FIG. 2 is a two-dimensional conceptual illustration of the technology of the present invention.

FIG. 3 is a three-dimensional top-side view of a preferred embodiment of the present invention.

FIG. 4 is a view into the parabolic reflector of the present invention.

FIG. 5 is side view of the parabolic reflector of the present invention.

FIG. 6 is a top view of a parabolic reflector of the present invention.

FIG. 7 is another embodiment of the present invention where the light source is placed at the focal point of the parabolic reflector.

FIG. 8 is another embodiment of the present invention where the light detector is placed at the focal point of the parabolic reflector.

FIG. 9 is a two-dimensional side view of a preferred embodiment of the present invention.

FIG. 10 is a two-dimensional side view of another preferred embodiment of the present invention.

FIG. 11 is a two-dimensional side view of another preferred embodiment of the present invention.

FIG. 12 is a top view of a preferred embodiment of the present invention.

FIG. 13 is a top view of another embodiment of the present invention, where the axes of symmetry of two parabolic reflectors are not parallel to z-axis.

FIG. 14 is a two-dimensional side view of another preferred embodiment of the present invention where two reflectors are elliptical mirrors.

### DETAILED DESCRIPTIONS OF THE PREFERRED EMBODIMENTS

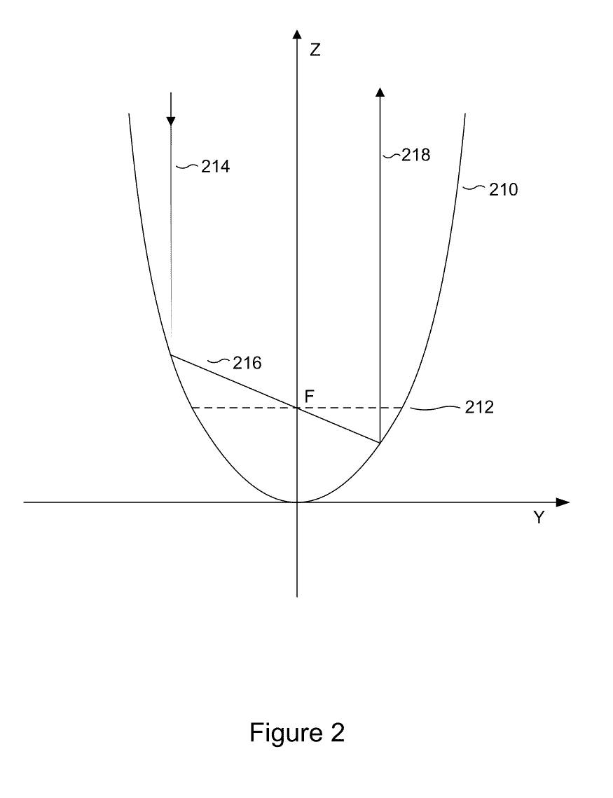

Referring to FIG. 2, a key underlying concept of the embodiments of the present invention is explained. Given a parabola 210 disposed on a y-axis and a z-axis, conceptually, the shape of the parabola can be described be a simple mathematical function, z=ay², where incoming rays parallel to the z-axis would intersect the z-axis at its focal point “F”, where the focal point is at (0, ¼a), and “a” is a constant. The incoming ray intersects the parabolic surface and it is redirected towards the focal point at the incident plane 212 (the plane that is perpendicular to the axis of symmetry and passes through the focal point, “F”).

Here, as shown, the incidental incoming light ray 214 is parallel to the axis of symmetry. The ray hits the parabolic surface and the parabolic reflector, by virtue of its properties, directs the beam towards its focal point and intersects the z-axis at intersection point “F”. After the intersection, the ray hits the parabolic surface again, and the parabolic surface re-directs the ray 218 back toward its incident direction parallel to the axis of symmetry. Due to the unique characteristic of the paraboloid, reflected ray will be always be parallel to the axis of symmetry if the incoming ray is parallel to the axis of symmetry.

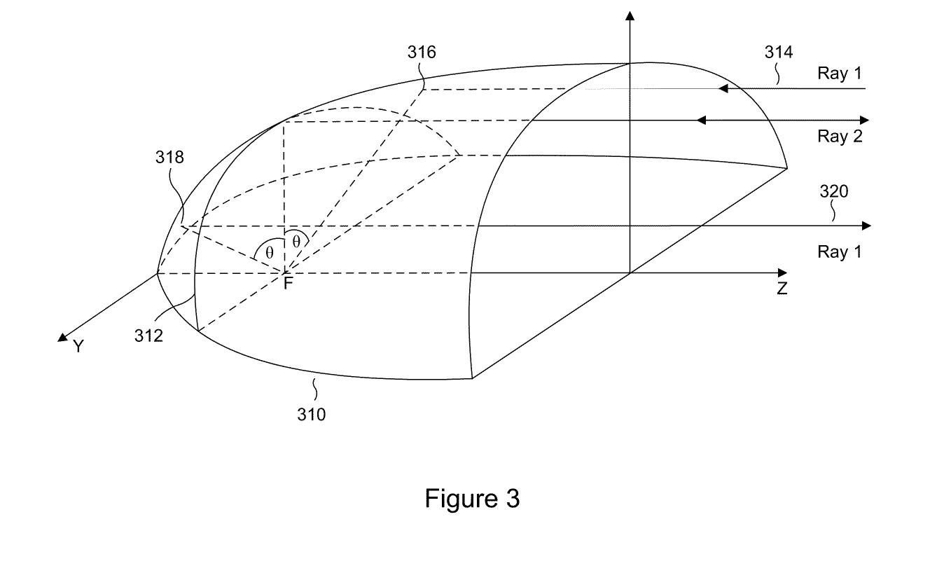

In a presently preferred embodiment of the present invention, referring to FIG. 3, a parabolic reflector 310, which can be in the shape of a half-paraboloid is illustrated. Here, the properties described above for two-dimensional parabolic shapes would hold as well. For example, an incoming ray 314, ray 1, that is coming in parallel to the axis of symmetry, would reflect off the parabolic surface at 316. The reflected ray would, due to the characteristics of the paraboloid, be directed to the focal point of the paraboloid, point “F”, which is also the point of intersection between the intersection plane 312 and the z-axis, the axis of symmetry. The ray would reflect off point “F”, create information with respect to the DUT (not shown) and again reflect off a point off the parabolic surface 318 and be re-directed out 320 of the parabolic reflector, which would be read by a detector (not shown). Again, due to the unique characteristic of the paraboloid, reflected ray will be always parallel to the axis of symmetry if the incoming ray is parallel to the axis of symmetry.

The shape of the embodiments of the present invention can be a paraboloid, which can be manufactured by rotating a parabolic curve around its axis of symmetry. The reflector can be made by cutting the paraboloid in two halves along its axis of rotation. In actual use, the preferred embodiment of the present invention can be slightly less than one-half of the paraboloid such that the axis of symmetry of the paraboloid can be located on the surface of the DUT to be measured or inspected. The inner surface of the parabolic reflector would be reflective.

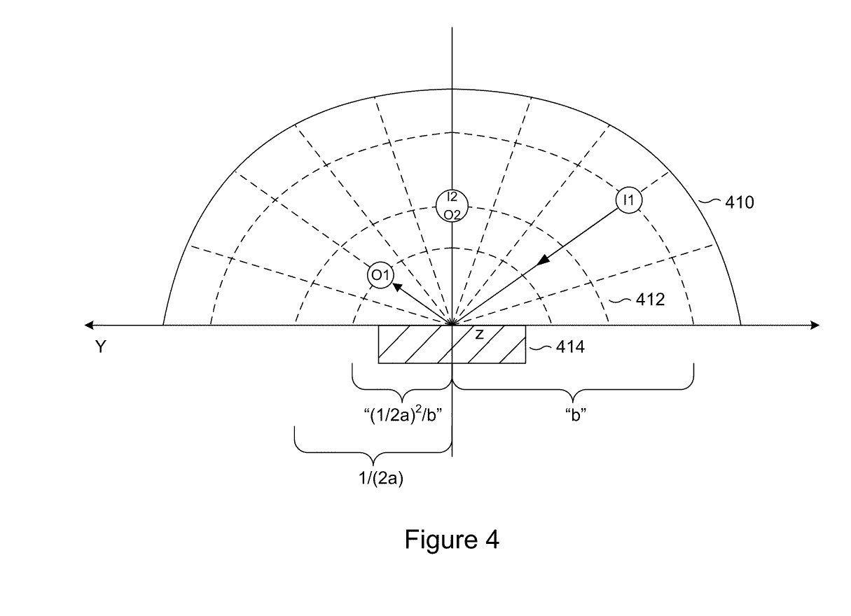

Depending on where the ray intersects the parabolic surface, the ray will intersect the flat surface at different incident and azimuth angles. The relationship between the intersection point on the parabolic surface and the ray angle can be easily calculated. Referring to FIG. 4, in looking into the opening of the parabolic reflector, if we look toward the reflected beam, the parabolic reflector looks like a half hemisphere. Let's image there is a polar coordinates at the end surface of the reflector, the cross-section of incoming beam is a quarter of circle, and the cross-section of the reflected beam is also quarter of circle.

The rays incoming at radius of 1/(2a) will also exit at the same radius (see incoming ray 1 “I1” and outgoing ray 1 “O1”). It is also easy to show that any incoming ray intersects that parabolic surface at a distance from the axis of symmetry of “b”, then the exit ray will intersect the parabolic surface at a distance of (½a)²/b. The angle measured at plane of incidence will be same. So, in polar coordinate (ρ, θ), if the incoming ray has coordinates (ρ, θ), the exit ray will have coordinates of (r²/ρ, π-2θ), where r=1/(2a). A ray, such as ray 2 (“I2” and “O2”) coming in parallel with the z-axis would also exit parallel with the z-axis.

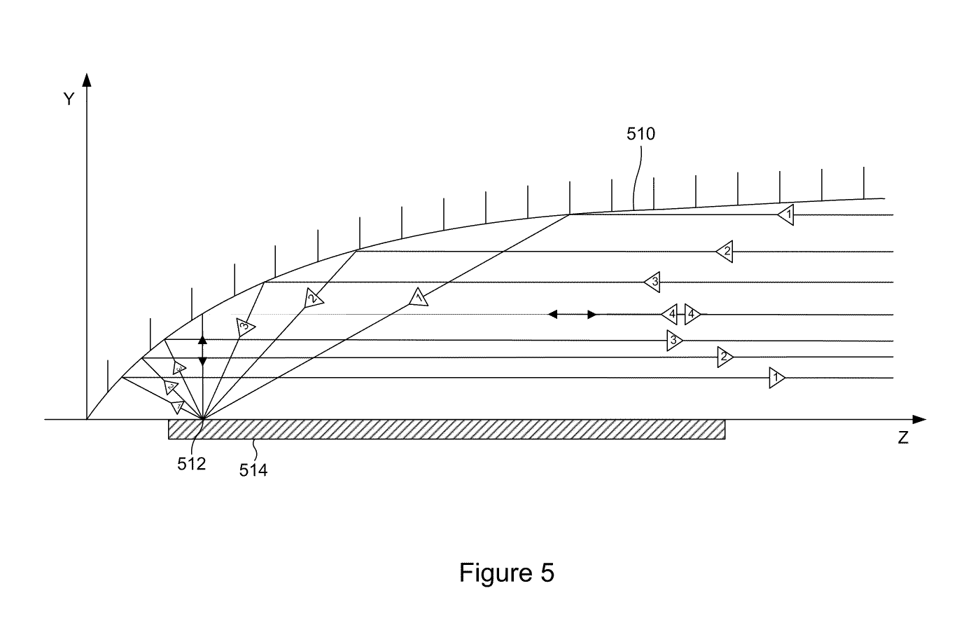

Referring to FIG. 5, a side view of the reflector 510 is illustrated. Here, the focal point (0, ¼a) is at 512, and the DUT can be fairly large when compared to traditional inspection systems. Here, Rays 1, 2, 3 and 4 are coming in parallel with the z-axis, and, as illustrated, after hitting the DUT, the rays are re-directed and reflect off the reflector and re-directed out of the reflector.

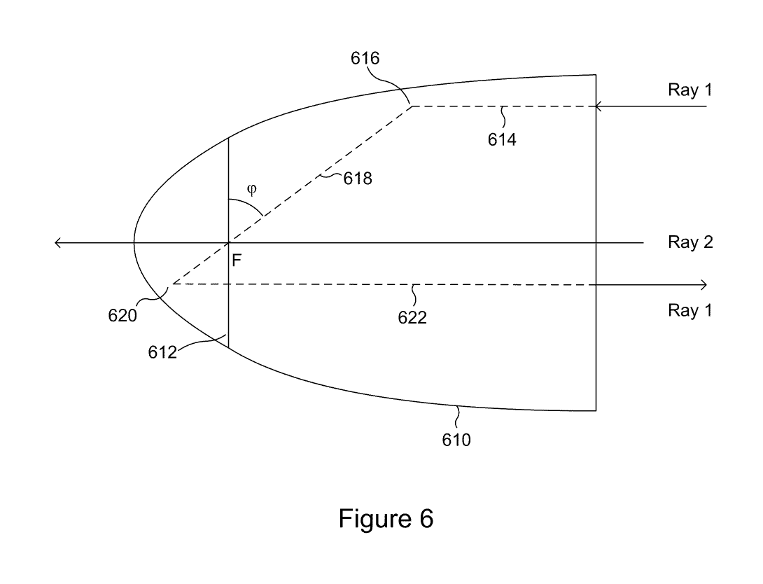

Referring to FIG. 6, a top view of the reflector 610 is illustrated with a plane of incidence 612 and azimuth angle φ. Here, ray 1 comes in 614 parallel to the z-axis and reflects off a point 616 off the reflector and is re-directed 618 to the focal point of the reflector. It then reflects off the DUT (not shown) and again it reflects off the reflector at 620 and exits the reflector parallel to the z-axis 622. Ray 2 enters along and parallel to the z-axis and exits along the same path.

The exiting rays, since it has been reflected off the device-under-test, their characteristics would provide information indicative of the device-under-test. The reflected light rays would be collected by a detecting device and analysis of the reflected light rays would then be conducted. The detecting device can be any type depending on the nature of the inspection work or measurement work.

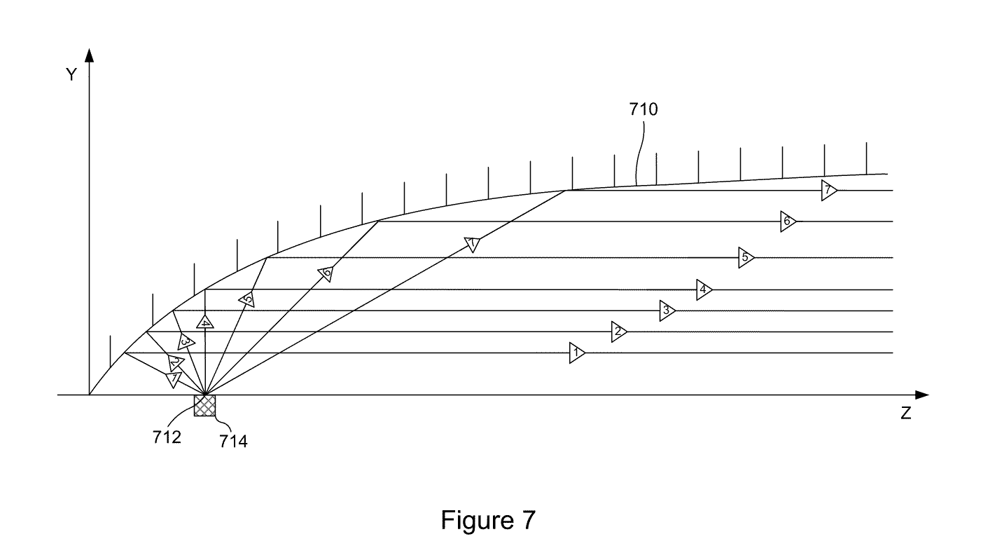

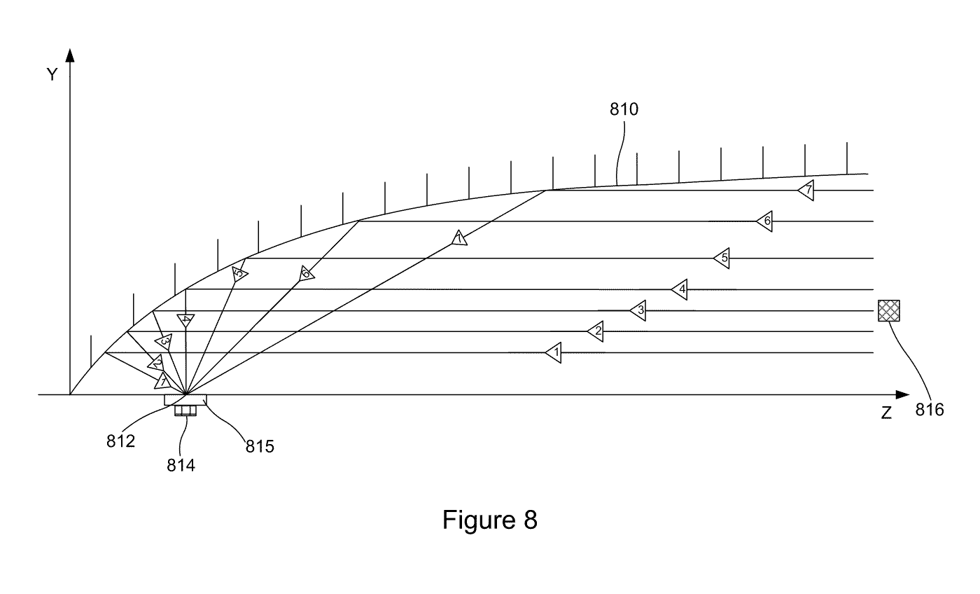

Referring to FIG. 7, in yet another embodiment of the present invention, a light source 714 can be place at the focal point 712, resulting in light emitting from the focal point and be re-directed to generate collimating beams in exiting the reflector. Referring to FIG. 8, in yet another embodiment of the present invention, a light detector 814 can be placed at the focal point 812 to collect light beams coming into the reflector. In yet another embodiment, a light source can be placed at the focal point (see FIG. 7) and a detector 815 can be placed at the focal point (see FIG. 8) as well to collect any light reflected from any DUT 816, where the DUT can be placed at the opening of the reflector. Alternately, the light detector can be placed at the back of the reflector to collect the collimating beams.

### DETAILED DESCRIPTION OF AN ALTERNATIVE EMBODIMENT

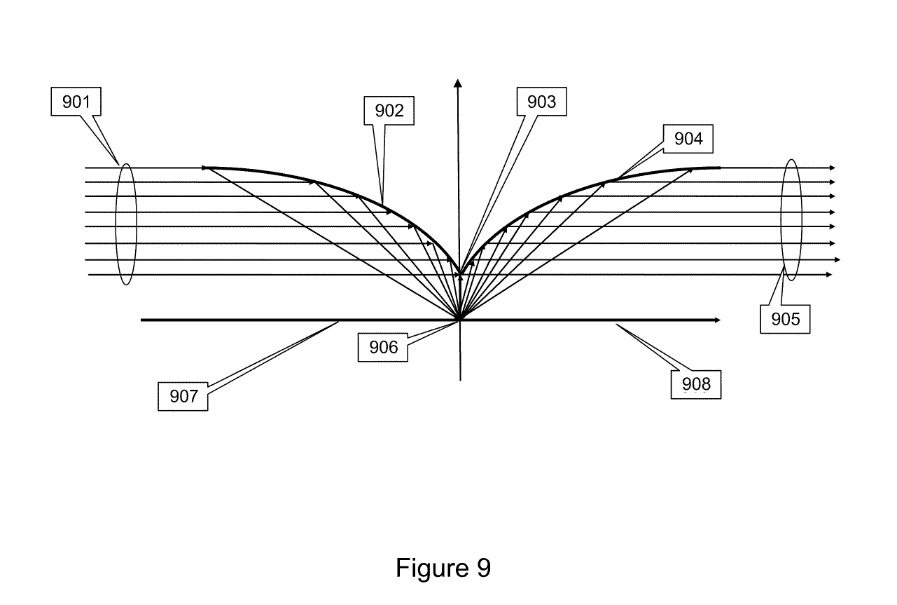

FIG. 9 is a two-dimensional side view of a preferred embodiment of the present invention. In this embodiment, two parabolic reflectors 902 and 904 are positioned such that the two parabolic reflectors 902 and 904 share a common focal point 906 and share a common axis of symmetry 907. The focal point 906 is disposed on a DUT 908.

Given that the parabolic reflector 902 is disposed on a y-axis and a z-axis (conceptually), collimated incoming light rays 901 parallel to the z-axis can intersect the z-axis at its focal point 906. The incoming light rays 901 intersect the parabolic reflector's 902 surface, and are redirected towards the focal point 906 at an incident plane 903, where the incident plane is perpendicular to the DUT 908 and passes through the common focal point 906.

As shown, the incidental incoming light rays 901 are parallel to the axis of symmetry 907. The incoming light rays 901 hit the parabolic reflector's 902 surface. By virtue of its properties, the parabolic reflector 902 directs the beam towards its focal point 906, which intersects the DUT 908. After reflecting off the surface of the device-under-test 906, the light rays enter the second parabolic reflector 904. The parabolic reflector 904 collimates the outgoing rays 905 to the direction parallel to the axis of symmetry 907. In this embodiment, due to the unique characteristic of the paraboloid, exiting reflected rays 905 are always parallel to the common axis of symmetry 907, if the incoming rays 901 are parallel to the common axis of symmetry 907.

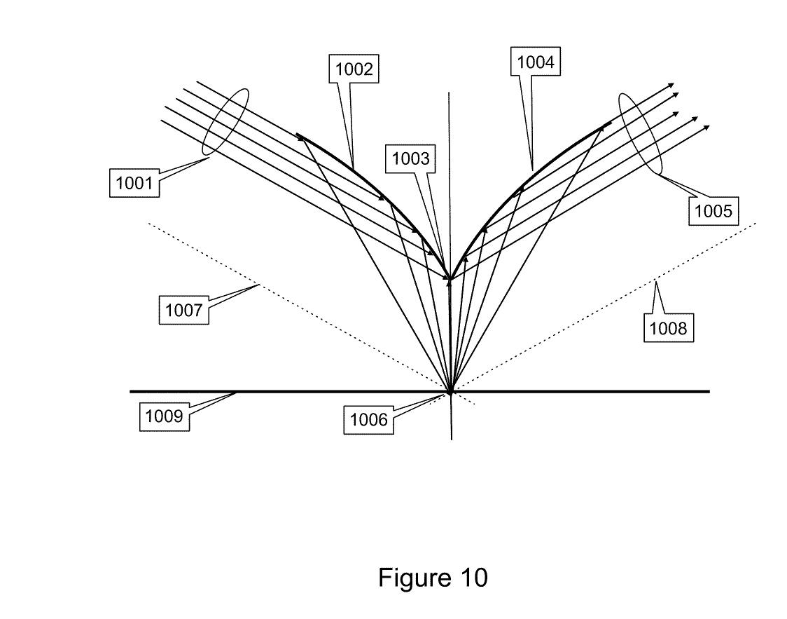

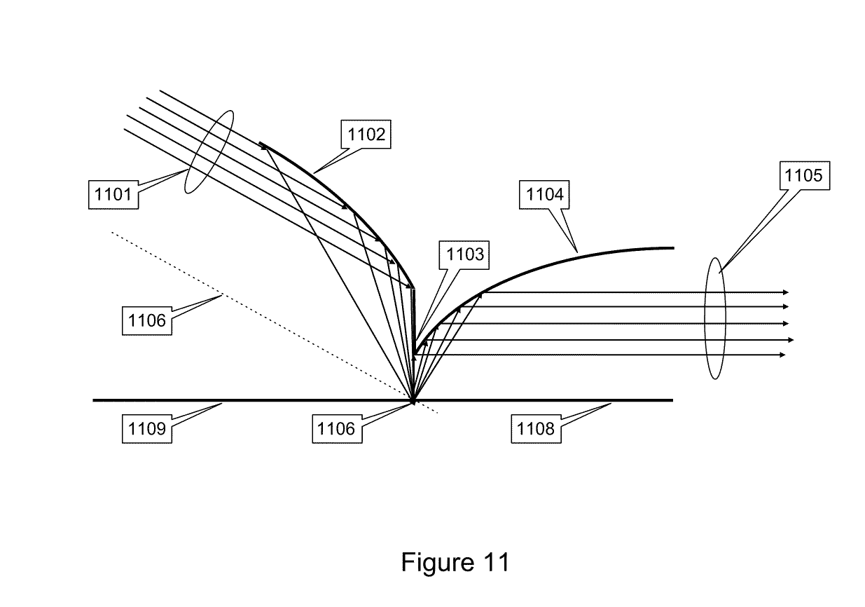

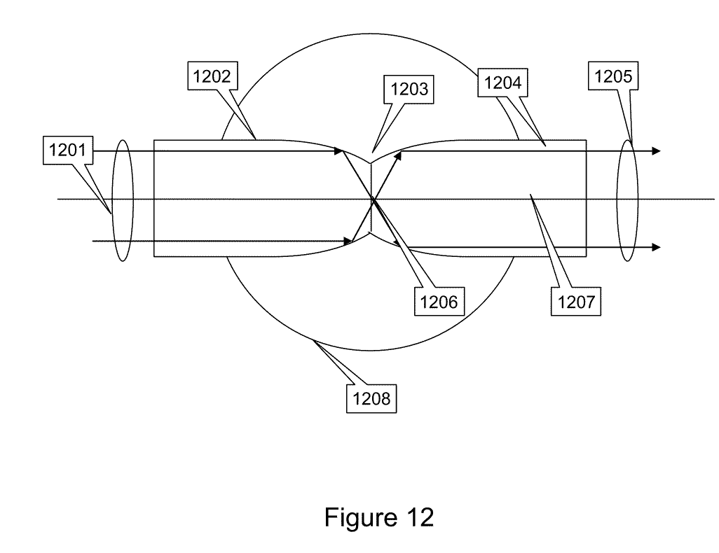

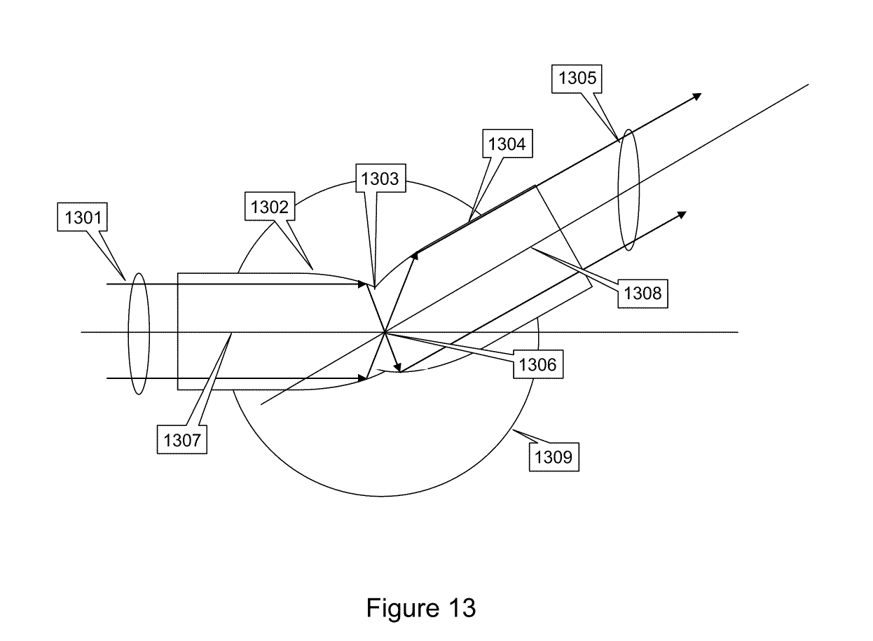

However this invention can also work as long as the focal points of multiple parabolic reflectors overlap, as shown in FIG. 10, FIG. 11, FIG. 12, and FIG. 13.

FIG. 10 is a two-dimensional side view of another preferred embodiment of the present invention. In this embodiment, two parabolic reflectors 1002 and 1004 share a common focal point 1006, but do not share a common axis of symmetry. Instead, an axis of symmetry 1007 for the parabolic reflector 1002 and an axis of symmetry 1008 for the parabolic reflector 1004 are angled from an incident plane 403. The angles from the incident plane 403 to each of the axes of symmetry 1007 and 1008 are equal.

As shown, the incidental incoming light rays 1001 are parallel to the axis of symmetry 1007. The incoming light rays 1001 hit the parabolic reflector's 1002 surface. By virtue of its properties, the parabolic reflector 1002 directs the beam towards its focal point 1006, which intersects a DUT 1009. After reflecting off the surface of the DUT 1009, the rays enter a second parabolic reflector 1004. The parabolic reflector 1004 collimates the outgoing rays 1005 to the direction parallel to the axis of symmetry 1008. It is important to note that incoming light rays can be received at any angle and outgoing light rays can be transmitted at any angle since the axes of symmetry can be set any angle.

FIG. 11 is a two-dimensional side view of another preferred embodiment of the present invention. In this embodiment, two parabolic reflectors 1102 and 1104 share a common focal point 1106, but do not share a common axis of symmetry. Instead, an axis of symmetry 1106 for the parabolic reflector 1102 and an axis of symmetry 1108 for the parabolic reflector 1104 are angled from a incident plane 1103. The angle from the incident plane 1103 to each of the axes of symmetry 1106 and 1108 are not equal, hence giving an asymmetrical appearance for the parabolic reflectors 1102 and 1104.

As shown, the incidental incoming light rays 1101 are parallel to the axis of symmetry 1106. The incoming light rays 1101 hit the parabolic reflector's 1102 surface. By virtue of its properties, the parabolic reflector 1102 directs the beam towards its focal point 1106, which intersects a DUT 1109. After reflecting off the surface of the DUT 1109, the light rays enter the second parabolic reflector 1104. The parabolic reflector 1104 collimates the outgoing rays 1105 to the direction parallel to the axis of symmetry 1108.

FIG. 12 is a top view of a preferred embodiment of the present invention. It can represent the top view for various embodiments of the invention, e.g. illustrated in FIG. 3, FIG. 4, and FIG. 5. Here, the two axes of symmetry are in the same plane.

As shown, incidental incoming light rays 1201 are parallel to an axis of symmetry 1207. The incoming light rays 1201 hit a parabolic reflector's 1202 surface. By virtue of its properties, the parabolic reflector 1202 directs the beam towards its focal point 1206, which intersects a DUT 1208. After reflecting off the surface of the DUT 1208, the light rays enter a second parabolic reflector 1204. The parabolic reflector 1204 collimates the outgoing rays 1205 to the direction parallel to the axis of symmetry 1207.

FIG. 13 is a top view of another embodiment of the present invention, where the axes of symmetry of two parabolic reflectors are not parallel to z-axis, and therefore not in the same plane. The beam can be steered not along a horizontal line but at any angle with respect to the Z-axis.

As shown, incidental incoming light rays 1301 are parallel to an axis of symmetry 1307. The incoming light rays 1301 hit a parabolic reflector's 1302 surface. By virtue of its properties, the parabolic reflector 1302 directs the beam towards its focal point 1306, which intersects a DUT 1309. After reflecting off the surface of the DUT 1309, the light rays enter a second parabolic reflector 1304. The parabolic reflector 1304 collimates the outgoing rays 1305 to the direction parallel to an axis of symmetry 1308.

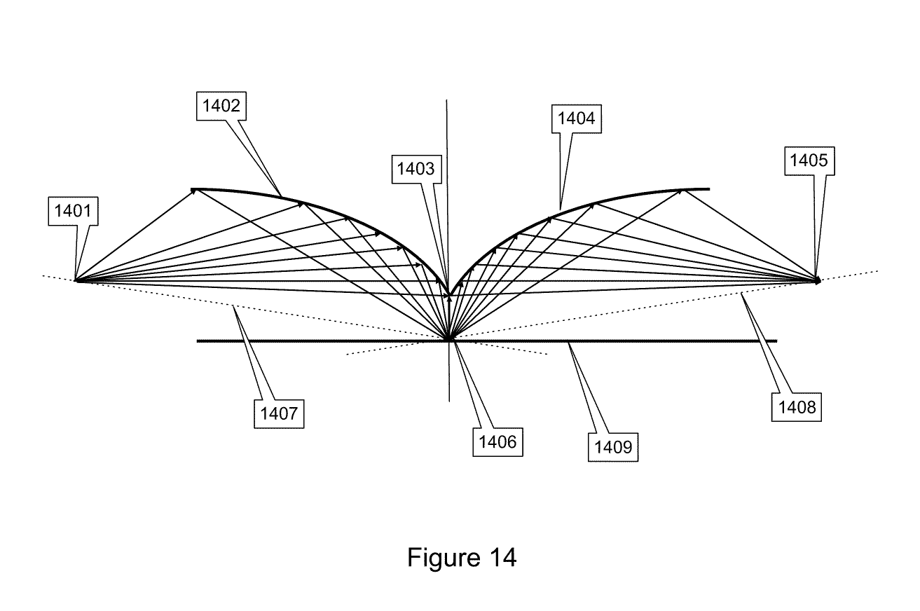

Furthermore, this invention is not limited to parabolic reflectors. In fact, elliptical reflectors can also work, as shown in FIG. 14. In this embodiment, two elliptical reflectors 1402 and 1404 share a common focal point 1406. An axis of symmetry 1401 for the elliptical reflector 1402 and an axis of symmetry 1408 for the elliptical reflector 1404 are angled from an incident plane 1403.

As shown, incidental incoming light rays from a focal point 1401 of the elliptical reflector 1402 enter the elliptical reflector 1402, and are reflected off the elliptical reflector's 1402 surface to the other focal point 1406 of the elliptical reflector 1402. The incident light rays on the focal point 1406 are reflected off the DUT 1409 and enter the elliptical reflector 1404. Since the two elliptical reflectors 1402 and 1404 share the common focal point 1406, the elliptical reflector 1404 will focus the outgoing rays to its other focal point 1405.

In other embodiments of the present invention, a combination of a parabolic reflector and a elliptical reflector can be used in which both types of reflectors share a focal point.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. An optical device, comprising:
a light source for providing incoming light rays;
a first conic-shaped reflector having a reflecting surface;
a second conic-shaped reflector having a reflecting surface, wherein said first reflector and said second reflector have a common focus point for directing incoming light rays on a device-under-test and collecting outgoing light rays from the device-under-test; and
a detecting device for collecting the reflected light rays reflected off from said device-under-test.

2. A method as described in the disclosure above.

3. A device as described in the disclosure above.
